(19) United States
(12) Patent Application Publication
(10) Pub. No.: US 2017/0157443 A1
(43) Pub. Date: Jun. 8, 2017

(54) Decorating Fixed Structure Of Concealed Fire Sprinkling Head

(71) Applicant: PROTECTOR SAFETY IND., LTD., Taoyuan County (TW)

(72) Inventor: Jung-Wen Chen, Taoyuan County (TW)

(21) Appl. No.: 15/067,018

(22) Filed: Mar. 10, 2016

(30) Foreign Application Priority Data
Dec. 2, 2015 (TW) 104219323

(51) Int. Cl. A62C 35/68; B05B 15/00

(52) U.S. Cl. CPC A62C 35/68; B05B 15/001

(57) ABSTRACT

The invention relates to a decorating fixed structure of a concealed fire sprinkling head comprising: a fastening piece fastened to a sprinkling head, a plurality of legs being extending and formed at a periphery of the fastening piece; and a decorating cover adhered to the legs via a low temperature melting metal to be disposed at a bottom of the fastening piece, wherein an amount of the legs formed at corresponding locations correspondent to two ends of the fastening piece is two. Accordingly, the difficult problem to increase a temperature sensing speed of the concealed fire sprinkling head is solved.

### BACKGROUND OF THE INVENTION

1. Field of the Invention

The present invention relates to a structural technique of a concealed fire sprinkling head, particularly to a decorating fixed structure of a concealed fire sprinkling head.

2. Description of Related Art

For the conventional general fire sprinkling heads, the sprinkling head and its connected pipes are concealed in the ceiling in order to show a decorating mask. The decorating mask comprises a fastening piece and a decorating cover. The decorating cover is mounted on the sprinkling head by using the fastening piece so that the decorating cover is adhered to a bottom of the fastening piece. The decorating cover is used to cover the sprinkling head in order to prevent the sprinkling head from directly exposing on the ceiling and to increase beauty of the whole ceiling.

Please refer to FIG. 1 demonstrating for the conventional general fire sprinkling head the decorating mask comprises a fastening piece 20 and a decorating cover 30. The decorating mask is mounted at a periphery of the fire sprinkling head 1 so as to conceal the fire sprinkling head on the ceiling. In view of the mounting way of the decorating mask, the decorating cover 30 is adhered and fixed to a bottom of the fastening piece 20 and the fastening piece 20 is assembled on the fire sprinkling head 1. The decorating cover 30 is adhered and fixed to a bottom of the fastening piece 20 by using a low temperature melting metal (for example, tin) for adhering. When high temperature of a hot air of a fire causes the low temperature melting metal to be melt down so as to drop the decorating cover 30 from the fastening piece 20, the hot air contacts with the temperature sensing glass rod 12 to be cracked down in order to open a fire pipe to spray water.

The general fastening piece 20 is adhered to the decorating cover 30 by three legs 25 made by extending from the fastening piece 20. The low temperature melting metal located between the three legs 25 and the decorating cover 30 is slowly melt down by high temperature environment of a fire, and an adhering force will gradually decrease. When the adhering force of the low temperature melting metal is smaller than the dropping force of the affecting gravity force of the decorating cover 30, the decorating cover 30 drops from a bottom of the fastening piece 20 and the hot air contacts with the temperature sensing glass rod 12 to be cracked down in order to open the fire pipe to spray water.

On the other way, alternatively the low temperature melting metal is slowly melt down by high temperature environment of a fire to decrease the adhering force, the heat contacts with the temperature sensing glass rod 12 to be cracked down in order to open the water valve to spray water, and flushing force of a water flow will force the decorating cover 30 dropped from the bottom of the fastening piece 20 momentarily.

When a fire occurs, the faster the decorating cover drops from the bottom of the fastening piece, the less are the damages of the fire. How to increase the dropping speed of decorating cover from the bottom of the fastening piece will be a technology subject to be studied and overcomed.

### SUMMARY OF THE INVENTION

The objective of the present invention is to solve the problem of difficulty to increase a sensing speed of a concealed fire sprinkling head by means of providing a decorating fixed structure of a concealed fire sprinkling head.

In order to achieve the objective, the technical plan of this invention is to provide a decorating fixed structure of a concealed fire sprinkling head comprising:

a fastening piece fastened to a sprinkling head, a plurality of legs being extending and formed at a periphery of the fastening piece; and

a decorating cover adhered to the legs via a low temperature melting metal to be disposed at a bottom of the fastening piece,

wherein an amount of the legs formed at corresponding locations correspondent to two ends of the fastening piece is two.

In one preferred embodiment of the present invention, an ear portion preferably extends and is formed at two ends of the fastening piece, and the legs are respectively formed at a bottom of the ear portion.

According to the present invention, the decorating cover is preferably a cup-shaped body and a cavity for receiving the sprinkling head is formed in the decorating cover.

According to the present invention, at least one ventilating hole for fluidly connecting to the cavity is preferably formed on a surface of the decorating cover.

According to the present invention, the decorating cover is preferably a disk-shaped body.

According to the present invention, at least one ventilating hole is preferably formed on a surface of the decorating cover.

According to the above techniques of this invention, after comparison with the well-know techniques the advantages of the present invention are that as an objective of this invention to improve a slow dropping speed of the decorating cover dropped from a bottom of the fastening piece and to increase a slow speed of temperature sensing of the temperature sensing glass rod are to provide a decorating fixed structure of a concealed fire sprinkling head.

In one further preferred embodiment of the utility model, there is provided a decorating fixed structure of a concealed fire sprinkling head comprising:

a fastening piece fastened to a sprinkling head, a plurality of legs being extending and formed at a periphery of the fastening piece; and

a decorating cover adhered to the legs via a low temperature melting metal to be disposed at a bottom of the fastening piece,

wherein an amount of the legs formed at corresponding locations correspondent to two ends of the fastening piece is two.

In one preferred embodiment of the utility model, an ear portion preferably extends and is formed at two ends of the fastening piece, and the legs are respectively formed at a bottom of the ear portion.

According to the utility model, the decorating cover is preferably a cup-shaped body and a cavity for receiving the sprinkling head is formed in the decorating cover.

According to the utility model, at least one ventilating hole for fluidly connecting to the cavity is preferably formed on a surface of the decorating cover.

According to the utility model, the decorating cover is preferably a disk-shaped body.

According to the utility model, at least one ventilating hole is preferably formed on a surface of the decorating cover.

According to the above techniques of this utility model, after comparison with the well-know techniques the advantages of the utility model are that by using a design of only two legs the whole adhering force for fixing the decorating cover to the decorating cover is decreasing because the amount of legs of the decorating cover of the utility model is relatively smaller in comparison with a conventional design of only three legs. Thus, the low temperature melting metal is slowly melt down by heat, the decorating cover fast dropped from the bottom of the fastening piece in order to open the fire pipe to spray water and to decrease damages from the fire. By using the design of only two legs of the fastening piece, to simplify the complex structure is another advantage to decrease production cost of the fastening piece.

Other objectives, advantages, and novel features of the invention will become more apparent from the following detailed description when taken in conjunction with the accompanying drawings.

### BRIEF DESCRIPTION OF THE DRAWINGS

FIG. 1 is a three-dimensional explosive view of a first embodiment of a concealed fire sprinkling head of prior arts.

FIG. 2 is a three-dimensional explosive view showing the concealed fire sprinkling head of FIG. 1 of the present invention.

FIG. 3 is a top view of FIG. 2.

FIG. 4 is a cross-section view along line A-A of FIG. 3 of the invention.

FIG. 5 is a three-dimensional explosive view of a second embodiment of a concealed fire sprinkling head of the present invention.

### DETAILED DESCRIPTION OF THE PREFERRED EMBODIMENT

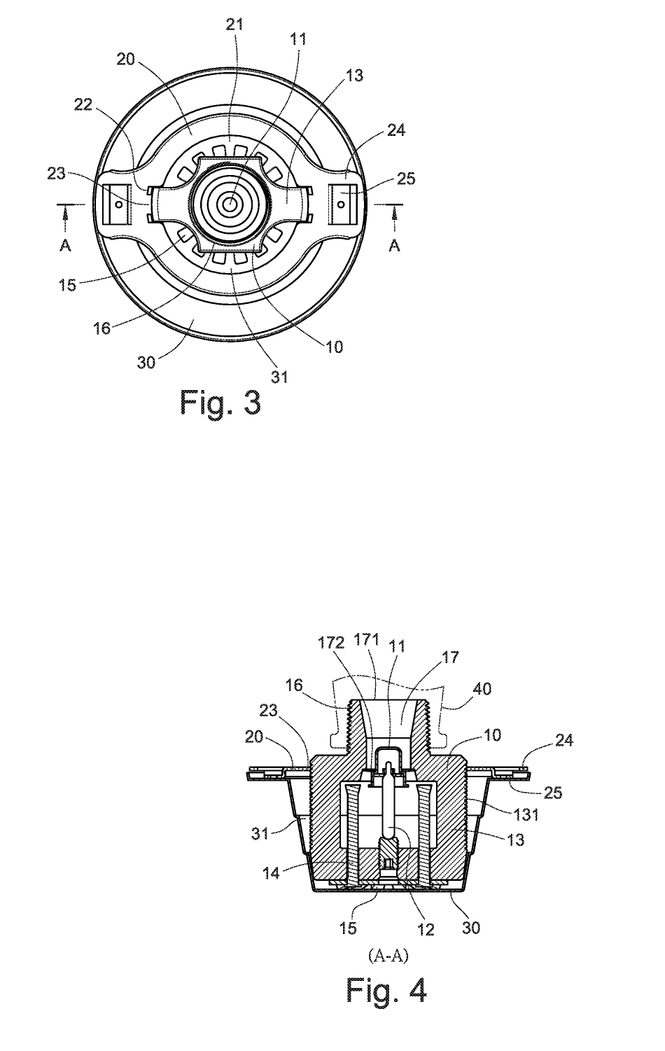

Please refer to FIGS. 2 to 4 which respectively disclose a configuration of a first preferred embodiment of the present invention demonstrating a decorating fixed structure of a concealed fire sprinkling head provided in the present invention comprising a fastening piece 20 and a decorating cover 30.

The fastening piece 20 is mounted on a sprinkling head 1. In more details, the sprinkling head 1 comprises a valve seat 10. A screw portion 16 is formed on a top end of the valve seat 10. The valve seat 10 can be mounted on a fire pipe 40 by the screw portion 16. A passage 17 is formed in the valve seat 10. At two ends of passage 17, a water inlet 171 and a valve hole 172 are respectively formed on a surface of the valve seat 10. The passage 17 is fluidly connected to the fire pipe 40 through water inlet 171 so that the water in the fire pipe 40 can be transferred from the passage 17 to the valve hole 172 via the water inlet 171 to drain out. In one embodiment, a water valve 11 is disposed at the valve hole 172. The water valve 11 can control a draining timing of the water in the fire pipe 40. A temperature sensing glass rod 12 is disposed at the bottom of the water valve 11. The temperature sensing glass rod 12 normally pushes upwardly to hold the water valve 11 to turn off the valve hole 172 to prevent the water in the fire pipe 40 from leakage to the outside.

Two ribs 13 are respectively formed at opposite axial sides of the passage 17 at two ends of the valve seat 10. The rib 13 is used for holding and positioning the temperature sensing glass rod 12 to maintain and to position in the valve seat 10. A guiding rod 14 which can move and slide in an axial direction of passage 17 is formed at a bottom side of the rib 13. A disk-shaped spoiler 15 which can form a water curtain from the water drained from the valve hole 172 by the spoiler 15 is fluidly connected to the guiding rod 14 in order to enhance a spraying area of the water.

In one embodiment the fastening piece 20 is a sheet-shaped body and the fastening piece 20 is fastened to the ribs 13 located at both sides of the valve seat 10. In one embodiment, a passing hole 21 for the sprinkling head to extend and to pass through the passing hole 21 is formed at a center of the fastening piece 20. A guiding groove 22 is respectively symmetrically formed at both inner sides of the passing hole 21. In more details, an inner diameter of the passing hole 21 is smaller than the outer diameter of the valve seat 10 to restrict a combining way between the valve seat 10 and the fastening piece 20 and to guide the fastening piece 20 to be fastened to the valve seat 10. Furthermore, a tongue strip-like clip hook 23 extends and is formed from an inner side of the guiding groove 22. A plurality of fastening slots 131 spaced apart each other are formed on the rib 13. In implementation, the fastening slot 131 is an outer tooth-shaped body. The clip hook 23 can be fastened in the fastening slot 131 so that the fastening piece 20 can regulate a level engaging position on the valve seat 10.

In implementation the decorating cover 30 is fixed to the bottom of the fastening piece 20. In more details, an ear portion 24 respectively extends and is formed from both outer sides of the fastening piece 20. A tongue strip-shaped leg 25 is formed at a bottom of the ear portion 24. The leg 25 is made by punching the ear portion 24. The leg 25 is bended downwardly and horizontally to exhibit an L-shaped body. The decorating cover 30 is adhered and fixed to a bottom of the leg 25 by adherence.

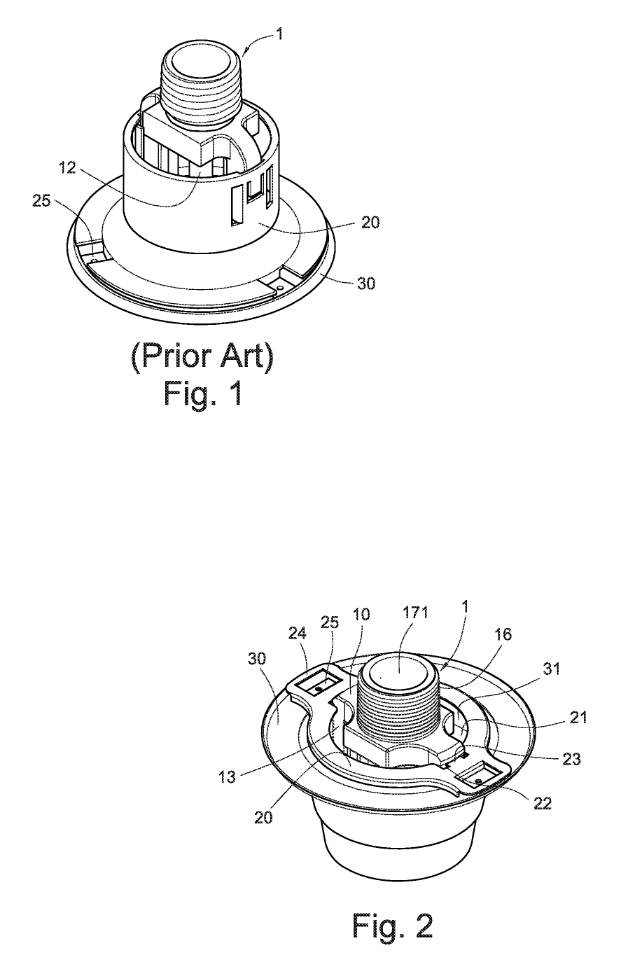

In implementation the decorating cover 30 is a cup-shaped body. A cavity 31 is formed in the decorating cover 30. In one embodiment the cavity 31 extends in the axial direction of the passage 17. The clip hook 23 can be fastened in the fastening slot 131 to regulate a level engaging position on the valve seat 10 so that the valve seat 10, the temperature sensing glass rod 12, the guiding rod 14 and the spoiler 15 can he axially positioned to a desired level in the cavity 31 along the passage 17. As shown in FIG. 1, when the decorating cover 30 is a disk-shaped body, for the fastening piece 20 a dropping speed dropped from the bottom of the fastening piece 20 is increased by means of a design of two legs 25.

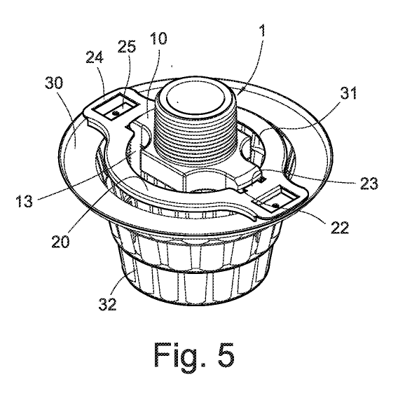

Please refer to FIG. 5 demonstrating a second embodiment of a decorating fixed structure of a concealed fire sprinkling head provided in the present invention. The differences between the second embodiment and the first embodiment of the present invention are a plurality of ventilating holes 32 which are formed on a surface of the decorating cover 30 by punching. Air flow can be guided by the ventilating holes 32 to fast contact with the temperature sensing glass rod 12 in the cavity 31 to increase the temperature of the temperature sensing glass rod 12. In implementation, the ventilating holes 32 can be designed using geometry shapes.

Although the present invention has been explained in relation to its preferred embodiment, it is to be understood that any other possible modifications and variations can be made without departing from the scope of the invention as hereinafter claimed.

We claim:

1. A decorating fixed structure of a concealed fire sprinkling head comprising:
a fastening piece fastened to a sprinkling head, a plurality of legs being extending and formed at a periphery of the fastening piece; and
a decorating cover adhered to the legs via a low temperature melting metal to be disposed at a bottom of the fastening piece,
wherein an amount of the legs formed at corresponding locations correspondent to two ends of the fastening piece is two.

2. The decorating fixed structure of the concealed fire sprinkling head as claimed in claim 1, wherein an ear portion extends and is formed at two ends of the fastening piece, and the legs are respectively formed at a bottom of the ear portion.

3. The decorating fixed structure of the concealed fire sprinkling head as claimed in claim 1, wherein the decorating cover is a cup-shaped body and a cavity for receiving the sprinkling head is formed in the decorating cover.

4. The decorating fixed structure of the concealed fire sprinkling head as claimed in claim 3, wherein at least one ventilating hole for fluidly connecting to the cavity is formed on a surface of the decorating cover.

5. The decorating fixed structure of the concealed fire sprinkling head structure as claimed in claim 4, wherein the decorating cover is a disk-shaped body.

6. The decorating fixed structure of the concealed fire sprinkling head structure as claimed in claim 5, wherein at least one ventilating hole is formed on a surface of the decorating cover.
